(19) United States
(12) Patent Application Publication
(10) Pub. No.: US 2007/0223325 A1
(43) Pub. Date: Sep. 27, 2007

(54) Optical disk apparatus

(76) Inventors: Shigeo Nakamura, Odawara (JP); Takeshi Shimano, Yokohama (JP); Irizo Naniwa, Odawara (JP); No-Cheol Park, Seoul (KR); Jeonghoon Yoo, Seoul (KR); Hyun Seok Yang, Seoul (KR); Dong-Ju Lee, Seoul (KR); Heoksoo Hong, Seoul (KR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/698,108

(22) Filed: Jan. 26, 2007

(30) Foreign Application Priority Data
Mar. 23, 2006 (JP) 2006-079901

(51) Int. Cl. G11B 7/00

(52) U.S. Cl. 369/44.19; 369/44.15

(57) ABSTRACT

There is provided a compact optical disc apparatus having a small footprint actuator. A tracking coil of a swing arm-type actuator is disposed substantially perpendicular to an arm and on the opposite side to an optical disc loading slot with respect to the line connecting the center of rotation of the optical disc to the center of swing movement of the actuator. A pair of permanent magnets are disposed such that they face the tracking coil and they are opposite in polarity. The tracking coil is disposed on both the permanent magnets such that the tracking coil straddles the boundary of the pair of permanent magnets.

### FIELD OF THE INVENTION

The present invention relates to an optical disc apparatus and a swing arm-type head positioning actuator.

### BACKGROUND ART

For example, JP Patent Publication (Kohyo) No. 2003-500787 and JP Patent Publication (Kokai) No. 5-135514 describe conventionally known technologies that relate to actuators of this type.

A magnetic disc apparatus or an optical disc apparatus using a rotating optical disc as a recording medium has a linear actuator that linearly moves a recording/reproducing or reproducing head or a swing arm-type (also called rotary type, rotation type and the like) actuator that swings such a head. To reduce the size of the apparatus, the swing arm-type actuator is used. In an optical disc apparatus, the actuator is responsible not only for positioning the head at a desired position in the radial direction of the optical disc, that is, a tracking operation, but also a focusing operation for maintaining a fixed distance between the head and the optical disc. In a compact optical disc apparatus, as described in JP Patent Publication (Kohyo) No. 2003-500787, the entire arm is tilted in the direction toward the optical disc (in the vertical direction when the optical disc is horizontally mounted) to maintain a fixed distance between the head and the optical disc.

In a disc apparatus using a swing arm-type actuator, in order to reduce the size of the disc apparatus, the centerline of the swing arm is in some cases inclined to the centerline of a tracking coil in a plane parallel to the optical disc. As shown in FIG. 6 of JP Patent Publication (Kokai) No. 5-135514, which describes an example of a magnetic disc apparatus, the tracking coil is disposed on the side of the center of disc rotation with respect to the line connecting the center of rotation of the swing arm-type actuator to the position where the magnetic head is attached.

[Patent Document 1] JP Patent Publication (Kohyo) No. 2003-500787

[Patent Document 2] JP Patent Publication (Kokai) No. 5-135514

### SUMMARY OF THE INVENTION

### PROBLEMS TO BE SOLVED BY THE INVENTION

However, the actuator described in JP Patent Publication (Kohyo) No. 2003-500787 is configured such that the tracking coil and the focusing coil are linearly disposed with the center of swing movement therebetween, resulting in a large footprint of the actuator. In a disc apparatus which an optical disc is loaded into and unloaded from with the optical disc surface horizontally oriented, the structure described in JP Patent Publication (Kokai) No. 5-135514 causes interference of the optical disc with the actuator when the optical disc is loaded.

An object of the present invention is to achieve an actuator with a small footprint and to provide a compact optical disc apparatus using the actuator.

### MEANS OF SOLVING THE PROBLEMS

The present invention provides an optical disc apparatus including one tracking coil disposed such that the center of the tracking coil is situated along the direction starting from the center of swing movement of the swing arm-type actuator and substantially perpendicular to the line connecting the center of swing movement of the swing arm-type actuator to the center of a lens of the optical pickup, and a pair of permanent magnets horizontally disposed such that the pair of permanent magnets face the tracking coil. The center of the tracking coil is situated on the opposite side to the center of optical disc rotation of an optical disc rotating mechanism on which an optical disc is placed with respect to the line connecting the center of swing movement of the swing arm-type actuator to the center of the lens of the optical pickup. The pair of permanent magnets are disposed such that the surfaces of the magnets that face the coil are opposite in polarity. The tracking coil is disposed above both the permanent magnets such that the tracking coil straddles the boundary between the pair of permanent magnets.

### EFFECTS OF THE INVENTION

According to the present invention, since the footprint of the actuator is small and the optical disc is removable, there is provided a compact optical disc apparatus.

### BRIEF DESCRIPTION OF THE DRAWINGS

FIG. 1 is a perspective view showing the actuator movable portion according to a first embodiment of the present invention;

FIG. 2 is a cross-sectional view of the first embodiment of the present invention taken along the line A-A shown in FIG. 1;

FIG. 3 is a plan view showing the optical disc apparatus according to the first embodiment of the present invention;

FIG. 4 is a perspective view of a structure in which a voice coil motor magnet 17 and a focusing magnet 26 are assembled to the actuator movable portion 1 according to the first embodiment of the present invention;

FIG. 5 is a cross-sectional view of the first embodiment of the present invention taken along the line B-B shown in FIG. 4;

FIG. 6 is a cross-sectional view of the voice coil motor magnet according to a second embodiment of the present invention;

FIG. 7 is a perspective view of the actuator movable portion according to a third embodiment of the present invention; and

FIG. 8 is a cross-sectional view of the third embodiment of the present invention taken along the line C-C shown in FIG. 7.

### DESCRIPTION OF THE PREFERRED EMBODIMENTS OF THE INVENTION

A first embodiment of the present invention will be described with reference to the drawings.

### First Embodiment

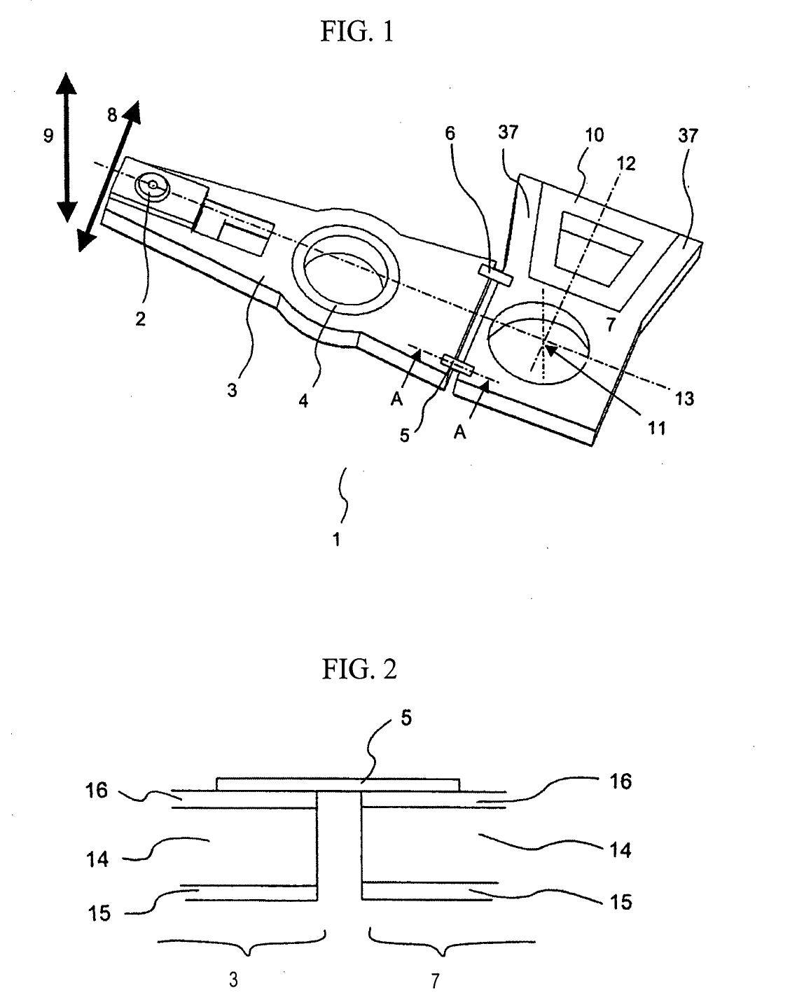

FIG. 1 is a perspective view showing an actuator movable portion 1 showing the first embodiment of the present invention.

An optical pickup 2 for recording/reproducing or reproducing information is disposed at the tip of a swing arm-type actuator 3.

The swing arm-type actuator 3 carries a focusing coil 4. Two hinges 5 and 6 connect the swing arm-type actuator 3 to a coil holder 7 that is fixed to a swingable pivot. The hinges 5 and 6 can move the swing arm-type actuator 3 in a manner integral with the coil holder 7 in a tracking direction 8 of the optical pickup 2, while moving the swing arm-type actuator 3 in another direction, which is a focusing direction 9 of the optical pickup 2.

The coil holder 7 carries a tracking coil 10.

The tracking coil 10 is disposed such that the center of the tracking coil 10 is situated along the direction starting from the center of swing movement 11 of the swing arm-type actuator 3 and substantially perpendicular to the line 13 connecting the center of swing movement 11 of the swing arm-type actuator 3 to the center of a lens of the optical pickup 2. This layout allows a shorter total length of the actuator movable portion 1.

To simply reduce the total length of the actuator movable portion 1, the line 12 connecting the center of the tracking coil 10 to the center of swing movement 11 may not be set at substantially right angles with respect to the line 13 connecting the center of the lens of the optical pickup 2 to the center of swing movement 11, but may be set at an arbitrary angle according to a required footprint.

However, the tracking coil 10 has a torsional vibration mode around the line 12 connecting the center of the tracking coil 10 to the center of swing movement 11. Therefore, the vibration mode is disadvantageously excited when the tracking coil 10 is driven in combination with a voice coil motor magnet 17, which will be described later.

The thus excited vibration will not affect the vibration of the optical pickup 2 in the tracking direction 8 by setting the line 12 connecting the center of the tracking coil 10 to the center of swing movement 11 to be substantially perpendicular to the line 13 connecting the optical pickup 2 to the center of swing movement 11.

FIG. 2 is a cross-sectional view of the actuator shown in FIG. 1 taken along the line A-A. Each of the swing arm-type actuator 3 and the coil holder 7 has a three-layer structure in which an aluminum plate 14 is sandwiched between stainless steel plates 15 and 16. The hinges 5 and 6 are formed of stainless steel plates, and connected to the swing arm-type actuator 3 and the coil holder 7 by means of welding.

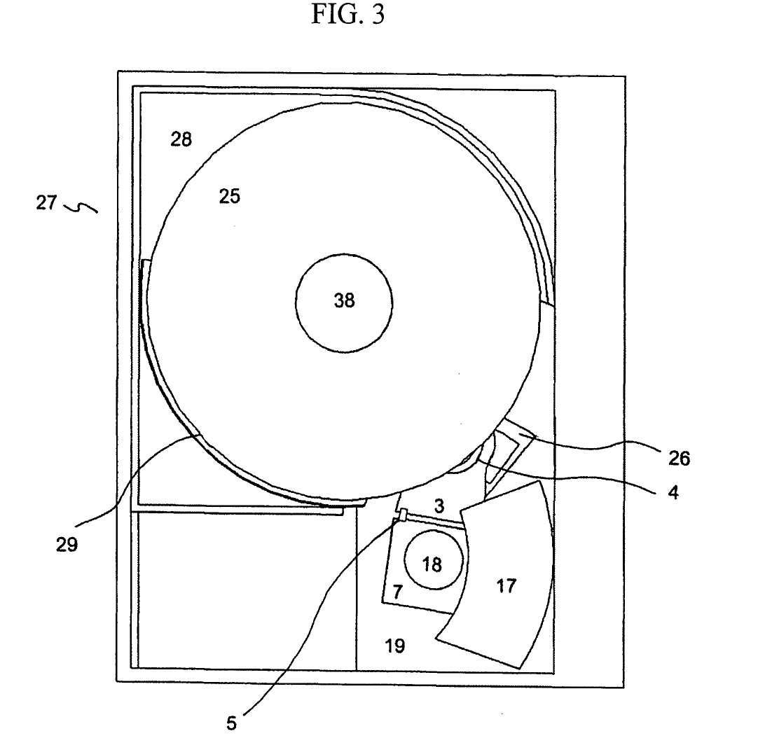

FIG. 3 is a plan view showing a mechanical portion of an optical disc apparatus using a structure in which the voice coil motor magnet 17 and a focusing magnet 26 are assembled to the actuator movable portion 1 shown in FIG. 2. The coil holder 7 is fixed to a pivot 18 swingable in the tracking direction 8.

The pivot 18 is fixed to a base 19.

When a cartridge 28 containing an optical disc 25 is loaded into an optical disc loading slot 27, a shutter 29 of the cartridge 28 opens and the optical disc 25 faces the optical pickup 2.

Since the tracking coil 10 and the voice coil motor magnet 17 are situated on the opposite side to the optical disc loading slot 27 with respect to the swing arm-type actuator 3, the position where the cartridge 28 is placed in the horizontal plane is determined by considering only interference of the cartridge 28 with the swing arm-type actuator 3.

That is, as shown in FIG. 3, when the optical disc loading slot 27, the optical disc 25 and the actuator movable portion 1 are disposed from the left in the plane of FIG. 3, shaping the actuator movable portion 1 into an L-shape can provide a configuration in which the cartridge 28 does not interfere with the tracking coil 10 and the voice coil motor magnet 17 when the cartridge 28 is loaded.

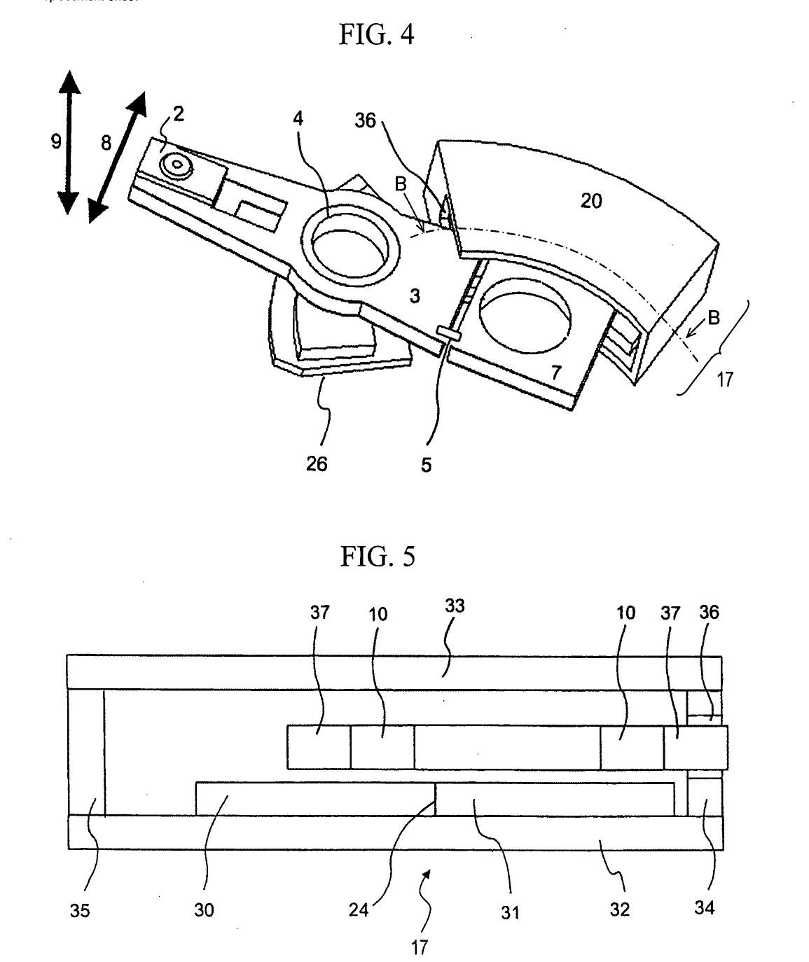

The direction in which the tracking coil 10 is attached with respect to the swing arm-type actuator 3 varies according to the position of the optical disc loading slot 27. The tracking coil 10 is not only situated on the opposite side to the center of optical disc rotation of an optical disc rotating mechanism on which the optical disc 25 is placed, but also disposed on the opposite side to the optical disc loading slot 27 with respect to the line connecting the center of rotation of the optical disc 25 to the center of the swing movement 11 of the actuator movable portion 1. FIG. 4 is a perspective view of a structure in which the voice coil motor magnet 17 and the focusing magnet 26 are assembled to the actuator movable portion 1 shown in FIGS. 1 and 2.

FIG. 5 is a cross-sectional view of the structure taken along the line B-B shown in FIG. 4 in which the voice coil motor magnet 17 and the focusing magnet 26 are assembled to the actuator movable portion 1.

As shown in FIG. 5, the voice coil motor magnet 17 is configured such that a pair of permanent magnets 30 and 31 are horizontally placed to face the tracking coil 10 in a box-shaped yoke 20.

The box-shaped yoke 20 is formed of a pair of yokes 32 and 33 and a pair of walls 34 and 35. The permanent magnets 30 and 31 are disposed side by side on the lower yoke 32 and joined therewith. The permanent magnets 30 and 31 are opposite in polarity in the vertical direction. That is, when the surface of the permanent magnet 30 that is joined with the lower yoke 32 is the north pole, the surface of the permanent magnet 30 that faces the upper yoke 33 is the south pole, while the surface of the permanent magnet 31 that faces the upper yoke 33 is the north pole and the surface of the permanent magnet 31 that is joined with the lower yoke 32 is the south pole.

The yoke 32 under the voice coil motor magnet 17 is fixed to the base 19 shown in FIG. 3.

The tracking coil 10 is disposed between the permanent magnets 30, 31 and the upper yoke 33 such that the tracking coil 10 straddles a polarity change line 24 of the voice coil motor magnet 17, that is, the boundary between (joined surface of) the permanent magnets 30 and 31. Feeding current through the tracking coil 10 induces an electromagnetic force in the tracking direction 8 shown in FIG. 1, and the electromagnetic force can position the optical pickup 2 at a desired radial position of the optical disc 25, which is an information storage medium.

The wall 34 has a cutout 36 through which the coil holder 7 can pass when the optical pickup 2 moves to the inner radius side of the optical disc 25. Provision of the cutout 36 allows the wall 34 to be disposed right next to the permanent magnet 31, and hence the size of the box-shaped yoke 20, that is, the size of the voice coil motor magnet 17 can be reduced.

If there is no cutout 36, it is necessary to provide a space for disposing a tracking coil carrying arm 37 of the coil holder 7 between the permanent magnet 31 and the wall 34, resulting in an decreased size of the box-shaped yoke 20, that is, an increased size of the voice coil motor magnet 17. This causes a problem of interference with the optical disc rotating mechanism 38. This problem can be solved by providing the cutout 36.

The focusing coil 4 is disposed above the focusing magnet 26.

Feeding current through the focusing coil 4 induces a force in the focusing direction 9 shown in FIG. 1. The force in the focusing direction 9 applied to the focusing coil 4 tilts the swing arm-type actuator 3 around the hinges 5 and 6, which serve as the center of rotation, and moves the optical pickup 2 in the focusing direction 9. By controlling the current flowing through the focusing coil 4, the optical pickup 2 can be positioned above the optical disc 25 with a constant space therebetween.

In this way, the voice coil motor magnet 17 can position the optical pickup 2 at an arbitrary radial position of the optical disc 25, and the spacing between the optical pickup 2 and the optical disc 25 can be maintained at a constant value.

In this embodiment, although the material of the swing arm-type actuator 3 and the coil holder 7 has the three-layer structure in which the aluminum plate 14 is sandwiched between the stainless steel plates 15 and 16, the material of the swing arm-type actuator 3 and the coil holder 7 may be a single stainless steel plate, a single aluminum plate, engineering plastic reinforced with carbon fibers or glass fibers, silicon, a silicon-based compound or a laminate formed of a combination thereof.

When the surfaces of the swing arm actuator 3 and the coil holder 7 that are joined with the hinges 5 and 6 are stainless steel plates, the hinges 5 and 6 formed of stainless steel plates can be connected by means of welding as described in this embodiment.

When the surfaces of the swing arm actuator 3 and the coil holder 7 that are joined with the hinges 5 and 6 are aluminum plates or made of engineering plastic, silicon or a silicon-based compound, the hinges 5 and 6 formed of stainless steel plates can be connected by means of bonding.

When the material of the hinges 5 and 6 is a flexible printed circuit in which copper is sandwiched between polyimide layers, the hinges 5 and 6 can be joined by means of bonding independent of the material of the swing arm-type actuator 3 and the coil holder 7.

### Second Embodiment

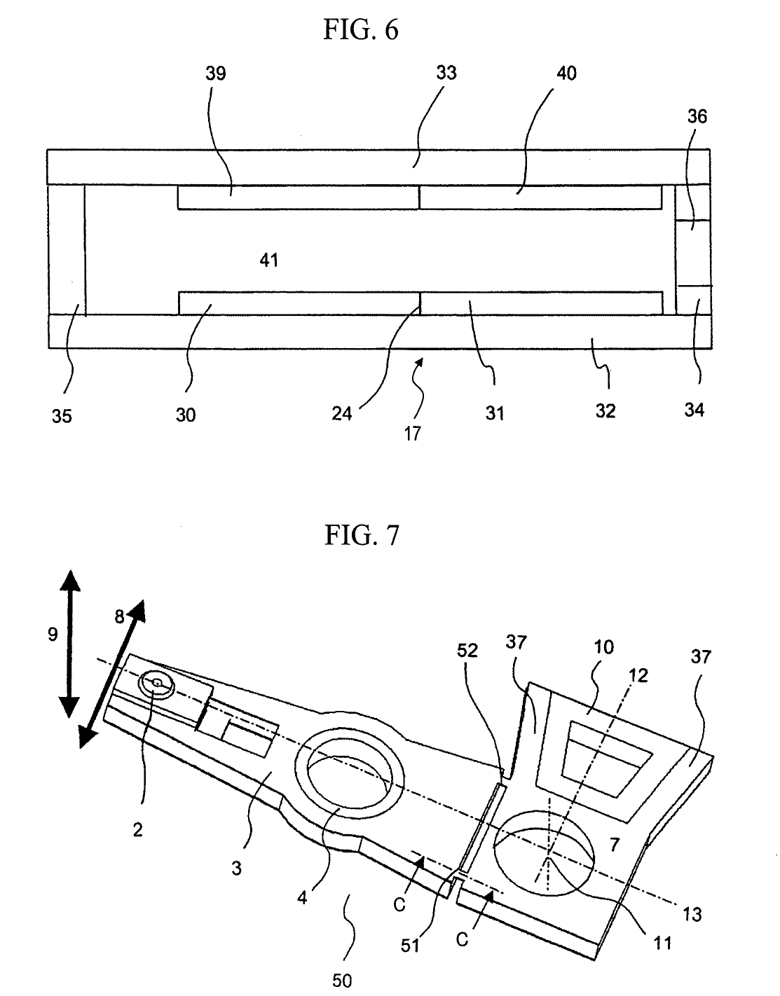

FIG. 6 is a cross-sectional view of the voice coil motor magnet 17 showing a second embodiment of the present invention.

The voice coil motor magnet 17 further includes a second pair of permanent magnets 39 and 40 as well as the pair of permanent magnets of the first embodiment. The permanent magnets 39 and 40 are joined with the upper yoke 33 such that the permanent magnets 39 and 40 faces the permanent magnets 30 and 31, respectively, and the polarities of the permanent magnets 39 and 40 are the same as those of the permanent magnets 30 and 31. That is, as described above, when the gap 41 side of the permanent magnet 30 is the south pole, the gap 41 side of the permanent magnet 39 is the north pole and the surface connected to the upper yoke 33 is the south pole, while the surface of the permanent magnet 40 that is connected to the upper yoke 33 is the north pole and the gap 41 side is the south pole.

In the second embodiment, the direction of the magnetic flux in the voice coil motor magnet 17 is more perpendicular to the lower yoke 32, as compared to the first embodiment. This voice coil motor magnet 17 can be combined with the actuator movable portion 1 of the first embodiment to achieve an actuator for an optical disc apparatus. In this case, when current is fed through the focusing coil 4 and the tracking coil 10 in respective predetermined directions, the focusing coil 4 and the tracking coil 10 generate forces more accurately in the focusing and tracking directions, respectively, as compared to the first embodiment. As a result, the focusing coil 4 and the tracking coil 10 twist the actuator movable portion 1 with smaller forces, thereby providing a compact actuator for an optical disc apparatus and a compact optical disc apparatus with an excellent vibration characteristic.

### Third Embodiment

FIG. 7 is a perspective view of an actuator movable portion 50 showing a third embodiment of the present invention.

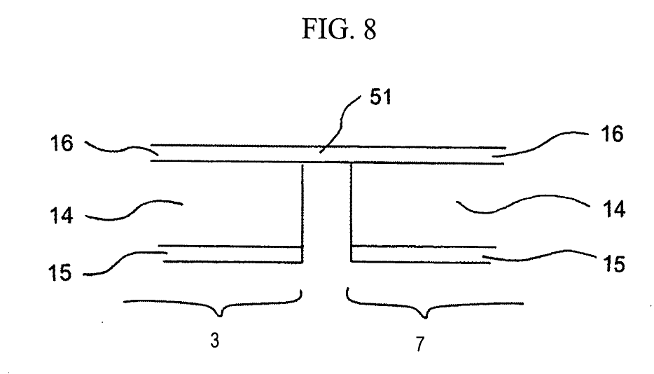

FIG. 8 is a cross-sectional view of the actuator movable portion 50 shown in FIG. 7 taken along the line C-C.

Each of the swing arm-type actuator 3 and the coil holder 7 of the actuator movable portion 50 has a laminated structure in which the aluminum plate 14 is sandwiched between the stainless steel plates 15 and 16, that is, a so-called cladding material. Hinges 51 and 52 are obtained by processing the stainless steel plate 16 into arbitrary shapes.

The hinges 51 and 52 can be fabricated by first performing etching, press working or electric discharge machining on the stainless steel plate 16 into an arbitrary shape, masking the stainless steel plate 16 and etching a desired portion of the opposite stainless steel plate 15 and the aluminum plate 14 or removing the desired portion by electric discharge machining.

In this embodiment, unlike the first and second embodiments, it is not necessary to join the hinges with the arm and the coil holder, so that an area necessary for joining is not required, allowing the size of the actuator movable portion 50 to be reduced. The area necessary for joining includes, in the case of welding, a welding portion and a flat portion around the welding portion necessary for holding the parts to be welded during the welding.

Furthermore, in this embodiment, since it is not necessary to join the hinges with the arm and the coil holder, the number of parts is fewer and hence the assembly accuracy, that is, the relative positional accuracy among the swing arm-type actuator 3, the coil holder 7 and the hinges 51 and 52 is high, allowing the actuator movable portion 50 to have less vibration and less variation in stiffness.

By replacing the actuator movable portion 50 with the actuator movable portion 1 of the first and second embodiments, a compact optical disc apparatus with less vibration and less variation in characteristics can be achieved.

As another method for fabricating the hinges 51 and 52, the stainless steel plate 16 shaped into flat hinges 51 and 52 may be laminated onto and joined with the aluminum plate 14 and the stainless steel plate 15.

In this embodiment, although the swing arm-type actuator 3 and the coil holder 7 use the cladding material in which the stainless steel plates 15 and 16 are laminated on the aluminum plate 14, the cladding material may be replaced with a laminated structure in which silicon oxide is sandwiched between silicon layers, that is, a so-called SOI (Silicon On Insulator). In this case, the thickness of one of the two silicon layers that sandwich the silicon oxide differs from thickness of the other one of the two silicon layers, and the hinges may be formed on the silicon layer having a smaller thickness.

Instead of the cladding material or the SOI, a single-layer plate made of etchable material is used for the swing arm-type actuator 3 and the coil holder 7. The single-layer plate is etched on the opposite side to the hinges 51 and 52 and the etching is terminated to leave a desired thickness of the hinges 51 and 52.

1. An optical disc apparatus using a swing arm-type actuator having tracking and focusing capabilities, the optical disc apparatus comprising:
an optical pickup disposed at the tip of the swing arm-type actuator;
one focusing coil disposed between the center of swing movement of the swing arm-type actuator and the optical pickup;
one tracking coil disposed such that the center of the tracking coil is situated along the direction starting from the center of swing movement of the swing arm-type actuator and substantially perpendicular to the line connecting the center of swing movement of the swing arm-type actuator to the center of a lens of the optical pickup; and
a pair of permanent magnets horizontally disposed such that the pair of permanent magnets face the tracking coil,
wherein the center of the tracking coil is situated on the opposite side to the center of optical disc rotation of an optical disc rotating mechanism on which an optical disc is placed with respect to the line connecting the center of swing movement of the swing arm-type actuator to the center of the lens of the optical pickup,
the pair of permanent magnets are disposed such that the surfaces of the magnets that face the coil are opposite in polarity, and
the tracking coil is disposed above both the permanent magnets such that the tracking coil straddles the boundary between the pair of permanent magnets.

2. The optical disc apparatus according to claim 1, wherein an optical disc loading slot is disposed on the opposite side to the tracking coil with respect to the line connecting the center of rotation of the optical disc to the center of the swing movement of the actuator.

3. The optical disc apparatus according to claim 1, wherein the optical pickup includes a light source and the lens.

4. The optical disc apparatus according to claim 1, further comprising a second pair of permanent magnets that face the pair of the permanent magnets, wherein the tracking coil is disposed between the pair of the permanent magnets and the second pair of the permanent magnets.

5. The optical disc apparatus according to claim 1, further comprising one or more hinges, each formed of a plate or a plate spring, which connect an arm that carries a focusing coil to a coil holder that carries the tracking coil, wherein the hinges are disposed between the center of swing movement of the coil holder and the optical pickup.

6. The optical disc apparatus according to claim 5, wherein the arm and the coil holder are made of cladding material in which multiple types of materials are laminated, the hinges are made of material different from the laminated cladding material, and the hinges are joined with the surface of the arm.

7. The optical disc apparatus according to claim 6, wherein the cladding material is formed of an aluminum plate or an aluminum plate-based alloy and stainless steel plates, and the hinges and the layer of the cladding material with which the hinge is joined are stainless steel plate layers.

8. The optical disc apparatus according to claim 4, wherein the cladding material is formed of an aluminum plate or an aluminum plate-based alloy and a stainless steel plate, and the hinges are formed by drawing the stainless steel plate of the cladding material.

9. The optical disc apparatus according to claim 1, further comprising a box-shaped yoke including upper and lower yokes disposed above and under the pair of permanent magnets, respectively, as well as two walls on both sides,
wherein at least one of the two walls has a cutout through which the tracking coil can pass.
